(19) United States
(12) Patent Application Publication
(10) Pub. No.: US 2003/0194917 A1
(43) Pub. Date: Oct. 16, 2003

(54) Electrical termination lug and terminal strip

(76) Inventor: Nate Mullen, Escondido, CA (US)

Correspondence Address: Joseph A. Yanny, Yanny & Smith, Suite 1260, 1925 Century Park East, Los Angeles, CA, 90067, US

(21) Appl. No.: 10/121,505

(22) Filed: Apr. 11, 2002

(51) Int. Cl. H01R 11/09

(52) U.S. Cl. 439/798

(57) ABSTRACT

The present invention comprises, among other things, an electrical termination lug and a terminal strip. The electrical termination lug is made out of a conductive material having a plurality of non-threaded cavities in which to receive conductors, and a plurality of threaded cavities in which to receive set screws. The terminal strip is adapted to retain the lugs, and is made out of non-conductive material. In addition, the terminal strip comprises, among other things, a first wall, a second wall, isolation walls, and retaining members. Further, the terminal strip member defines a hole through the first wall of the terminal strip and a hole through the second wall of the terminal strip member, each adjacent to one of the threaded and non-threaded cavities in the termination lug.

### CROSS-REFERENCE TO RELATED APPLICATION

Not Applicable.

### STATEMENT RE: FEDERALLY SPONSORED RESEARCH AND DEVELOPMENT

Not Applicable.

### FIELD OF THE INVENTION

The present invention relates to an electrical termination lug and a terminal strip. More specifically, the present invention relates to a plurality of electrical termination lugs wherein one of the lugs has a plurality of non-threaded terminals that are adapted for receiving conductors and a plurality of threaded terminals that are adapted for receiving set screws. In addition, the present invention relates to a terminal strip member that is adapted for retaining the lugs.

### BACKGROUND OF THE INVENTION

Generally, U.S. Pat. No. 3,576,520 ('520) discloses a mounting means for a plurality of terminal junction modules. The modules are made of a relatively firm plastic material and contain contact terminals that are secured onto ends of wires. The '520 patent also discloses that the mounting means comprises an elongated strip that is secured to a flat structure. In addition, the mounting means comprises a plurality of rigid retaining arms that extend from the left-hand side of the elongated strip and that have inwardly turned flanges at their end. The mounting means additionally comprise a plurality of resilient arms that extend from the right-hand side of the elongated strip and that are adapted to be resiliently bent outward. In operation, one of the modules is located against one of the rigid retaining arms with the flange of one of the arms extending into a recess of the module. The module is then pivoted about the flange and moved against the elongated strip with concomitant flexure of one of the resilient arms. After the module has been located against the surface of the plate section, the resilient arm springs inwardly so that a shoulder of the resilient arm holds the module in place upon the elongated strip.

Generally, U.S. Pat. No. 5,190,485 ('485) discloses an electrical termination lug. The lug is adapted to be attached to a buss bar or other suitable separating structure. The lug is a rectangular block member constructed of electrically conductive material. The lug defines a large opening adapted to receive a large conductor and a large threaded opening adapted to receive a large set screw. Furthermore, the lug defines a small opening adapted to receive a small conductor and a small threaded opening adapted to receive a small set screw. In operation, the large opening receives a large conductor, and a large set screw is screwed into the large threaded opening such that the large set screw secures the large conductor against a wall of the large opening. Similarly, the small opening receives a small conductor, and a small set screw is screwed into the small threaded opening such that the small set screw secures the small conductor against a wall of the small opening. The '485 patent further discloses that the lug may be connected to the buss bar or other suitable supporting structures of electrical equipment by any convenient means such as a by a mounting bolt.

A disadvantage of the prior art is that it does not use a plurality of electrical termination lugs in conjunction with a non-conducting terminal strip that keeps separate and removably retains the electrical termination lugs. Another disadvantage of the prior art is that it does not use a terminal strip that defines a hole for allowing a conductor to pass through the terminal strip and to be received by an electrical termination lug retained by the terminal strip. A further disadvantage of the prior art is that it does not use a terminal strip that defines a hole for allowing a set screw to pass through the terminal strip and to be received by an electrical termination lug retained by the terminal strip.

### ADVANTAGES OF THE INVENTION

One advantage of the present invention is that it teaches the use of a plurality of electrical termination lugs in conjunction with a non-conducting strip that keeps separate and removably retains the plurality of lugs.

Another advantage of the present invention is that it teaches the use of a terminal strip wherein the terminal strip defines a hole for allowing a conductor to pass through the terminal strip and to be received by one of the plurality of lugs.

A further advantage of the present invention is that it teaches the use of a terminal strip wherein the terminal strip defines a hole for allowing a set screw to pass through the terminal strip and to be received by one of the plurality of lugs.

A further advantage of the invention is that it allows a transformer to contain multiple electrically isolated termination lugs to conduct electricity of varying voltages in a compact and convenient manner.

### SUMMARY OF THE INVENTION

The present invention comprises, among other things, an electrical termination lug and a terminal strip. In the preferred embodiment of the present invention, the electrical termination lug is made out of a generally cubical shape of conductive material having a plurality of non-threaded cavities, and a plurality of threaded cavities. In the preferred embodiment of the present invention, the terminal strip is made out of a non-conductive material and comprises, among other things, first wall, a second wall, a plurality of isolation walls, and a plurality of retaining members. In addition, the terminal strip member defines a side terminal hole located between two isolation walls on the first wall, and defines a second hole located between two isolation walls on the second wall. During operation of the preferred embodiment of the present invention, an electrical termination lug is situated between two isolation walls of the terminal strip. A conductor, such as a wire, is inserted through the side terminal hole and into a non-threaded cavity of the electric terminal lug. A set screw is inserted through the second hole and is screwed into a threaded cavity that communicates with the non-threaded cavity into which the conductor is inserted. The set screw is screwed into the threaded cavity such that it contacts the conductor and secures the conductor against a wall of the non-threaded cavity.

### BRIEF DESCRIPTION OF THE DRAWINGS

FIG. 1A shows a perspective view of an electric terminal lug of the preferred embodiment of the present invention.

FIG. 1B shows a top view of an electric terminal lug of the preferred embodiment of the present invention.

FIG. 1C shows a front view of an electric terminal lug of the preferred embodiment of the present invention.

FIG. 1D shows a side view of an electric terminal lug of the preferred embodiment of the present invention.

FIG. 1E shows a bottom view of an electric terminal lug of the preferred embodiment of the present invention.

FIG. 1F shows a back view of an electric terminal lug of the preferred embodiment of the present invention.

FIG. 2A shows a perspective view of a terminal strip of the preferred embodiment of the present invention.

FIG. 2B shows a top view of a terminal strip of the preferred embodiment of the present invention.

FIG. 2C shows a close-up view of a terminal block positioned within a portion of the terminal strip of the preferred embodiment of the present invention.

FIG. 2D shows a side view of the terminal strip of the preferred embodiment of the present invention.

FIG. 2E shows a bottom view of the terminal strip of the preferred embodiment of the present invention.

### DETAILED DESCRIPTION OF THE INVENTION

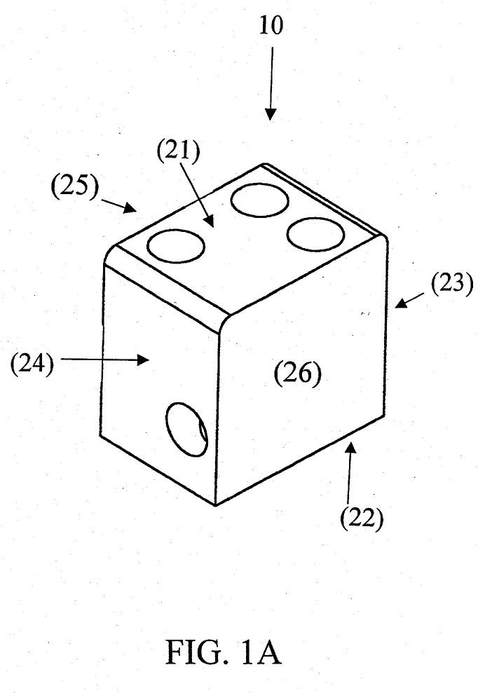

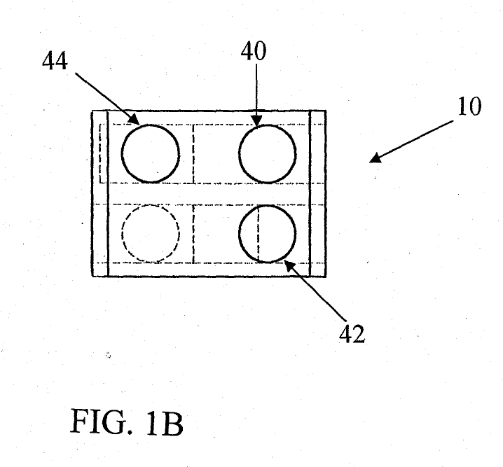

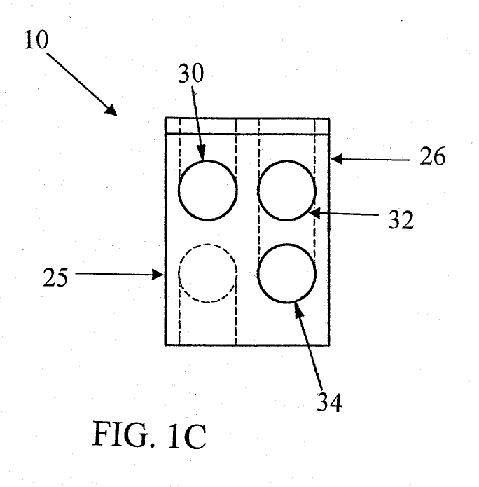

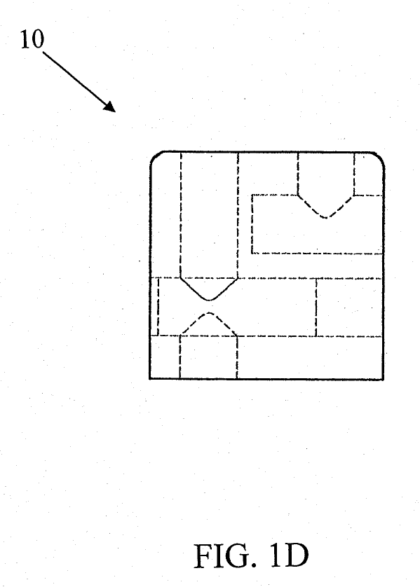

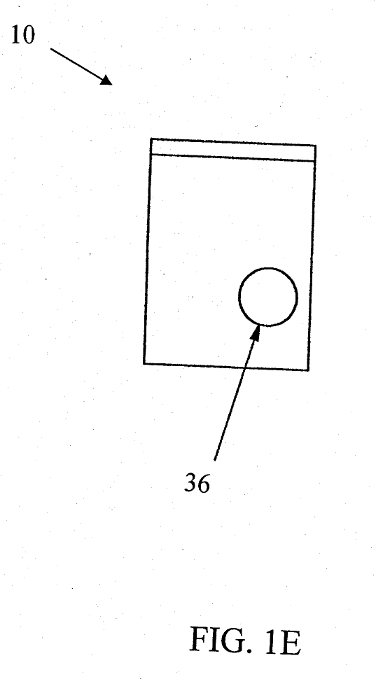

As shown generally in FIGS. 1A through 1F, the electrical terminal lug (10) of the preferred embodiment of the present invention generally comprises, among other things, a top side (21), a bottom side (22), a front side (23), a back side (24), a left side (25), and a right side (26). The lug (10) is made out of a conductive material and is generally cubical in shape. In addition, the lug (10) defines four non-threaded cavities (30, 32, 34, and 36). As shown with particularity in FIGS. 1C and 1D, a first non-threaded cavity (30) extends from the upper-left corner of the front side (23) and extends midway into the lug (10). A second non-threaded cavity (32) extends from the upper-right corner of the front side (23) and extends midway into the lug (10). A third non-threaded cavity (34) extends from the lower-right corner of the front side (23) and extends substantially through the lug (10). A fourth non-threaded cavity (36) extends from the lower-right corner of the back side (24) and extends midway through the lug (10).

Furthermore, the lug (10) defines four threaded cavities (40, 42, 44, and 46). As shown with particularity in FIGS. 1B and 1D, a first threaded cavity (40) extends from the left corner of the top side (21) near the front side (23) and extends far enough into the lug (10) to meet the first non-threaded cavity (30). A second threaded cavity (42) extends from the right corner of the top side (21) near the front side (23) and extends far enough into the lug (10) to meet the second non-threaded cavity (32). A third threaded cavity (44) extends from the right corner of the top side (21) near the back side (24) and extends far enough into the lug (10) to meet the third non-threaded cavity (34). A fourth threaded cavity (46) extends from the left corner of the bottom side (22) near the back side (24) and extends far enough into the lug (10) to meet the fourth non-threaded cavity (36).

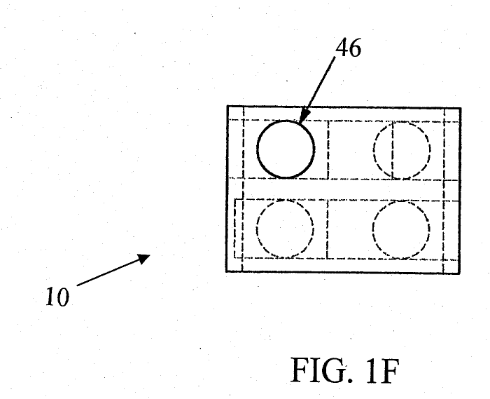

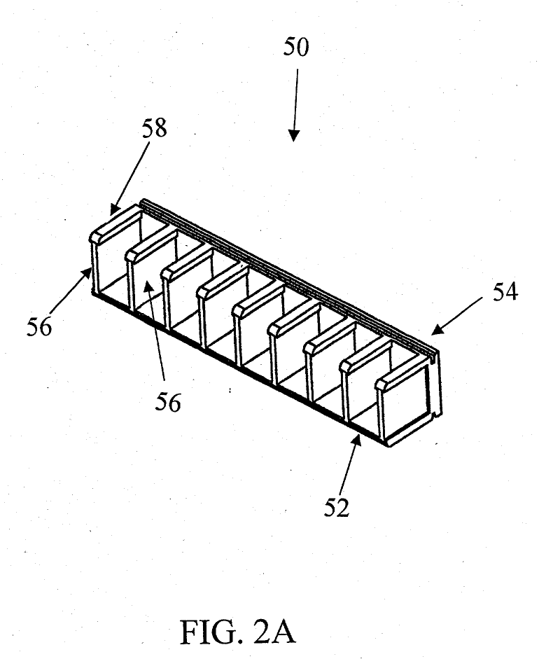

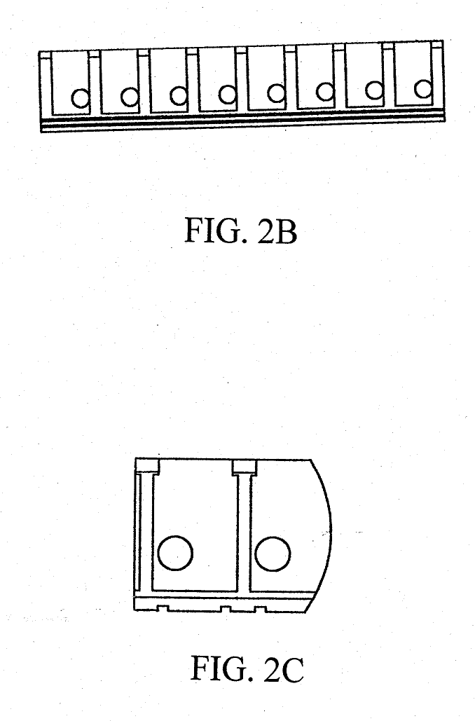

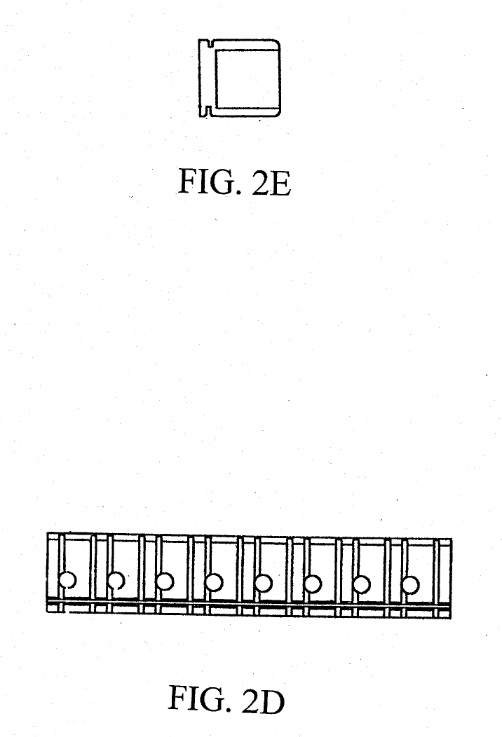

As shown in FIGS. 2A through 2D, generally the terminal strip (50) has a first wall (54), a second wall (52), and plurality of isolation walls (56). The isolation walls (56) are positioned far enough away from each other such that one of the lugs (10) snugly fits in between two isolation walls (56). In addition, the isolation walls (56) have a retaining member (58) substantially at the top of the isolation wall (56). The retaining member (58) substantially runs the length of the isolation wall (56) and has a width that is greater than the isolation wall (56). Generally, the retaining member (58) is adapted to retain the lug (10) between the isolation walls (56) such that movement of the lug (10) past the retaining members (58) and out of the terminal strip (50) is substantially limited. Furthermore, the first wall (54) defines a plurality of first holes (not shown) such that a first hole is defined through the first wall (54) in between isolation walls (56). Similarly, the second wall (52) defines a plurality of second holes (62) such that a second hole (62) is defined through the second wall (52) in between isolation walls (56).

In operation of the preferred embodiment of the present invention, an electrical termination lug (10), is positioned between isolation walls (56) of the terminal strip (50) such that the front side (23) and top side (21) face outward from the terminal strip (50). A conductor (not shown), such as a wire, is inserted through a first hole and into the fourth non-threaded cavity (36) of the lug, which is located on the lower-right corner of the back side (24). A retaining means such as a set screw (not shown) is inserted through the second hole (62) and into the fourth threaded cavity (46). The set screw is screwed into the fourth threaded cavity (46) such that it comes into contact with and secures the conductor against a wall (not shown) of the fourth non-threaded cavity (36). In further operation, a conductor (not shown) is inserted into the one or more of the three remaining non-threaded cavities (30, 32, and 34) that is located on the front (23) of the lug (10). A set screw is screwed into one of the four threaded cavities (40, 42, and 44) located on the top (21) that communicates with the non-threaded cavity (30, 32, or 34) into which the conductor is inserted.

The isolation walls (56) are made of a non-conducting material such as plastic or rubber, so as to prevent arcing between lugs (10). In the preferred embodiment, the isolation walls will be made out of the same type of plastic as the first and second walls of the terminal strip. The isolation walls (56) are connected to the first and second walls, and are positioned between lugs (10) such that the left side (25) and the right side (26) of each lug substantially contacts an isolation wall (56).

The above-described preferred embodiments are intended to illustrate the principles of the invention, but not to limit its scope. Other embodiments and variations of these preferred embodiments will be apparent to those skilled in the art and may be made without departing from the spirt and scope of the invention as defined in the following claims.

I claim:

1. An electrical termination system comprising:
a terminal strip further comprising:
a first wall;
a second wall connected to said first wall;
at least two isolation walls connected to said first wall and said second wall;
a retaining member connected to one of said isolation walls;
an electrical termination lug located between said isolation walls;
wherein said electrical termination lug defines:
at least two non-threaded cavities; and
at least two threaded cavities;
wherein one of said non-threaded cavities is in physical communication with one of said threaded cavities.

2. The electrical termination system of claim 1:
wherein said first wall defines a first hole; and
wherein said first hole is in physical communication with one of said non-threaded cavities.

3. The electrical termination system of claim 1:
wherein said second wall defines a second hole; and
wherein said second hole is in physical communication with one of said threaded cavities.

4. The electrical termination system of claim 1:
wherein said terminal strip further comprises:
a plurality of retaining members; and
wherein each of said plurality of retaining members is connected to one of said isolation walls.

5. The electrical termination system of claim 1:
wherein said terminal strip further comprises a plurality of electrical termination lugs;
wherein each of said plurality of termination lugs is located between two of said isolation walls.

6. The electrical termination system of claim 1:
wherein said electrical termination lug further comprises a plurality of retaining means; and
wherein each of said plurality of retaining means is located substantially within one of said plurality of threaded cavities.

7. An electrical termination system comprising:
a terminal strip further comprising:
a first wall;
a second wall connected to said first wall;
at least two isolation walls connected to said first wall and said second wall;
a plurality of retaining members;
wherein each of said plurality of retaining members is connected to one of said isolation walls;
an electrical termination lug located between two of said isolation walls; and
wherein said electrical termination lug defines:
at least two non-threaded cavities; and
at least two threaded cavities;
wherein each of said threaded cavities is in physical communication with one of said non-threaded cavities.

8. The electrical termination system of claim 7:
wherein said first wall defines a first hole; and
wherein said first hole is in physical communication with one of said non-threaded cavities.

9. The electrical termination system of claim 7:
wherein said second wall defines a second hole; and
wherein said second hole is in physical communication with one of said plurality of threaded cavities.

10. The electrical termination system of claim 7:
wherein said terminal strip further comprises a plurality of electrical termination lugs wherein each of said plurality of termination lugs is located between two of said isolation walls.

11. The electrical termination system of claim 7:
wherein said electrical termination lug further comprises a plurality of retaining means; and
wherein each of said plurality of retaining means is located substantially within one of said threaded cavities.

12. An electrical termination system comprising:
a terminal strip further comprising:
a first wall;
a second wall connected to said first wall;
a plurality of isolation walls connected to said first wall and said second wall;
a plurality of retaining members;
wherein each of said plurality of retaining members is connected to one of said plurality of isolation walls;
a plurality of electrical termination lugs;
wherein each of said plurality of electrical termination lugs is substantially located between two of said plurality of isolation walls;
wherein each of said plurality of electrical termination lugs further defines:
a plurality of non-threaded cavities;
a plurality of threaded cavities;
wherein each of said plurality of threaded cavities is in physical communication with one of said plurality of non-threaded cavities; and
a plurality of retaining means;
wherein each of said plurality of retaining means is located substantially within one of said plurality of threaded cavities.

13. The electrical termination system of claim 12:
wherein said first wall defines a plurality of first holes; and
wherein each of said plurality of first holes is in physical communication with one of said plurality of non-threaded cavities.

14. The electrical termination system of claim 12:
wherein said second wall defines a plurality of second holes; and
wherein each of said plurality of second holes is in physical communication with one of said plurality of threaded cavities.
